(19) United States
(12) Patent Application Publication
(10) Pub. No.: US 2002/0029515 A1
(43) Pub. Date: Mar. 14, 2002

(54) Modular synthetic grass turf assembly

(76) Inventor: Jean Prevost, Westmount (CA)

Correspondence Address: BIRCH STEWART KOLASCH & BIRCH, PO BOX 747, FALLS CHURCH, VA, 22040-0747, US

(21) Appl. No.: 09/944,167

(22) Filed: Sep. 4, 2001

(30) Foreign Application Priority Data
Sep. 1, 2000 (CA) 2,317,250

(51) Int. Cl. A01C 1/00

(52) U.S. Cl. 47/1.01 F

(57) ABSTRACT

A modular synthetic grass turf assembly includes a plurality of synthetic grass units which are transportable, adapted to be laid flat on a field and fit side by side to provide a flat and continuous synthetic grass surface for activities. Each unit includes a deformable and resilient base sheet preferably with drainage grooves and bores if it is for outdoor use. A synthetic grass turf with an infill layer of particulate materials disposed interstitially between synthetic grass fibers is attached to the top of the base sheet to provide a grass surface with a required quality. A number of units may have irregular shapes or be painted in different colors to illustrate letters, marks or logos. The modular synthetic grass turf assembly is conveniently transported from a storage facility to a site and assembled for a synthetic grass activity surface, such as sports playing surface, roadside advertisements or other applications. The primary advantage of this invention is the easy conversion from one type of sports field to another, or to other applications.

### TECHNICAL FIELD

The invention relates to a synthetic grass turf to provide a synthetic grass activity surface, and more particularly, to a modular synthetic grass turf assembly adapted to provide various field surfaces for multiple purposes.

### BACKGROUND ART

A stadium is a desirable venue for multiple purposes. Such a stadium may be used both for football and baseball activities as well as other social and civic events. This presents a challenge to the operator to convert the field surface to a different style for the particular sport or event and maintain the field quality that is required. This is especially difficult when such a conversion must be completed in a short period of time. For example, the Saturday afternoon baseball game field may need to be converted to a football game field for the Sunday afternoon game. Efforts have been made to develop a conversion system using natural grass trays which are well known in the industry. There are as many as 6,600 of these trays needed to be imported for a full field conversion from an artificial field surface to a natural grass surface. These natural grass trays prove to be very difficult and very costly to use since they are especially made not only to hold the natural grass but also to grow the grass thereon. The trays need appropriate drainage and moisture retention as well as an interlocking mechanism to keep them in place. The cost of maintaining these trays is enormous. They need to be tended to daily and the growing conditions are critical. Therefore, in winter, they need to be tracked south to grow and be maintained, or to be heated in winter use in northern climates. Such natural grass trays, for example, are described in U.S. Pat. No. 5,595,021, Jan. 21, 1997, and U.S. Pat. No. 5,17,894, Feb. 23, 1993, both to Ripley, Sr. et al. Ripley, Sr. et al describes natural turf units for stadia and other activity surfaces, which are transportable between first and second locations, the first location being a location for the performance of the desired activity, and the second location being for the growth and maintenance of the turf units.

Synthetic grass turf assemblies have been used instead, to provide game playing surfaces. The advantages of synthetic grass turf are well known. However, the existing infilled synthetic grass turf assemblies are generally for permanent installation in stadia, are not transportable and not adapted for conversion either entirely or in part.

Therefore, there is a need for a method of using infilled synthetic grass turf assemblies to provide convertible and transportable game playing surfaces.

### DISCLOSURE OF THE INVENTION

It is a primary object of the invention to provide a modular synthetic grass turf assembly adapted for conversion of a game playing surface to other applications or other sports.

It is another object of the invention to provide a modular synthetic grass turf assembly adapted to provide a transportable surface for temporary use in halls, gymnasia or other large areas that could be converted to part-time sports applications.

It is another object of the invention to provide a modular synthetic grass turf assembly adapted for use in permanent or temporary sites for roadside advertisements, logos, field lettering, field markings and the like.

It is a further object of the invention to provide a method for installing a synthetic grass turf assembly on a field using prefabricated synthetic grass units to reduce site work.

It is a still further object of the invention to provide a method for converting a sports field to other applications or other sports with fewer difficulties and at lower costs, In general terms in accordance with the present invention, there is a synthetic grass unit provided for a modular synthetic grass turf assembly. The unit comprises a base sheet, and a synthetic grass system supported on the top of the base sheet, the base sheet being adapted to be laid flat on a support surface and fit side by side with respect to other such synthetic grass units to provide a substantially flat, substantially continuous, synthetic grass turf surface. The base sheet preferably includes drainage means for draining water away from the unit, and the synthetic grass system preferably includes a synthetic grass turf with an infill layer of a particulate material disposed interstitially between the synthetic grass ribbons to provide a field quality that is required.

More especially, according to an embodiment of the invention, the base sheet is made of recycled plastic materials and extruded preferably with drainage grooves on a top and a bottom thereof forming a rectangular sheet having a thickness from a range of ¼ inch to 5″ inches. The base sheet may be provided in panels of 15 feet by 48′ feet. The synthetic grass system including an infill layer is installed on the top of the base sheet, and the base sheet is inherently flexible, to be laid flat in almost any weather on uneven surfaces within a tolerance of ½ inch or more. Therefore, the synthetic grass units can be installed on stabilized sand, crushed stone, asphalt, concrete, graded and compacted earth, on other artificial surfaces, and on any firm substrate to provide a synthetic grass surface with the field quality that is required.

In accordance with another aspect of the invention, there is provided a modular synthetic grass turf assembly which comprises a plurality of synthetic grass units. Each unit includes at least a base sheet and a synthetic grass system supported on a top thereof and the units are made to strict tolerances to ensure the units can individually fit side by side to provide a substantially flat, substantially continuous, synthetic grass surface when the units are laid flat on a field surface. The base sheets are made of extruded recycled plastic materials and rubberized laminated fabrics such as conveyor belt type of material that lays flat and is flexible, Preferably the sheets will have drainage grooves thereon and preferably in standard sizes and shapes, for example, a rectangular shape of 5 feet by 10 feet or 4 feet by 8 feet. The sheets can also be up to 40′ in length for the recycled plastic reinforced material, and from 15′ wide to 48′ long for the rubberized type of laminated or extruded fabric. These materials can vary from ¼ inch to 5 inches in thickness.

The modular synthetic grass turf assembly may also include a number of units having other than rectangular outlines and different colours representing letters, logos and other marks, and/or a number of units having such letters, logos and other marks, illustrated on the top thereof so that the modular synthetic grass turf assembly is adapted to have logos and marks installed on one or a pattern of units. The logos and marks can be changed quickly and at low cost for installing a visiting team's logo and name at one end of the field. Advertising can be placed on fields for short periods of time since they can be easily replaced with other advertising or just replaced with an all green surface that would not reflect any pattern as is seen on painted artificial turf surfaces.

The modular synthetic grass turf assembly is also adapted for easy use in permanent or temporary sites for road side advertisements, for municipal logos, for field lettering and markings, and for many other uses. The most likely use of the modular synthetic grass turf assembly according to the invention is for conversion of fields to other applications or other sports. As a transportable surface, it is also adapted for temporary use in halls, gymnasia, and other large areas that could be converted to part-time sports applications.

In accordance with a further aspect of the invention, a method is provided for installing a synthetic grass turf on a field. The method comprises steps of obtaining at a first location a plurality of synthetic grass units, each having a base sheet preferably with means for draining water away and a synthetic grass turf system secured on a top of the base sheet preferably with an infill layer of a particulate material disposed interstitially between the grass leaves; transporting the units from the first location to a second location to lay the units side by side on a prepared support surface to provide a substantially flat and substantially continuous synthetic grass surface; and top dressing the synthetic grass surface on site. If high drainage is required under the modular synthetic grass turf assembly, a geonet™ layer is preferably secured to the bottom of the base sheet of each unit at the first location, or when the units are fabricated. Drainage tiles can be rolled out independently from the modular units and then place them on the drainage tiles. The first location is usually a workshop or a storage house for receiving and storing the prefabricated base sheets and synthetic grass systems which come either separately or as in pre-assembled units. The latter is a more likely circumstance.

The support surface on which the modular synthetic grass turf is to be installed may be prepared with a surface made of stabilized sand, crushed stone, asphalt, concrete, graded and compacted earth, other artificial surfaces, or any firm substrate.

The advantage of a modular synthetic grass turf assembly is in the easy conversion of fields to other applications or other sports and the convenience for field and roadside advertisements. The synthetic grass units installed on the recycled plastic sheets or trays are easily handled by a forklift vehicle to which a metal plate has been mounted to its fork arms to actually lift the units. The storage area needed is far less than that which is required for the natural grass tray system. About 24 synthetic grass units can be stored on a standard 12 foot high storage rack. The units measuring 4 feet by 8 feet can weigh 460 lbs. each and, therefore, more than one unit can be carried by smaller forklift trucks or other battery operated lifting equipment. Some portable surfaces may weigh far less.

Other advantages and features of the invention will be better understood with reference to the preferred embodiments described below.

### BRIEF DESCRIPTION OF THE DRAWINGS

Having thus generally described the nature of the invention, reference will now be made to the accompanying drawings showing, by way of illustration, preferred embodiments in which:

FIG. 1 is a schematic cross-sectional view of a modular synthetic grass turf unit incorporating a preferred embodiment of the invention;

FIG. 2 is a similar view to that illustrated in FIG. 1, showing a forklift vehicle used to lift the unit for transportation and installation;

FIG. 3 is a perspective sketch, showing a sheet of metal attached to the forklift arms for supporting the unit thereon;

FIG. 4 is a side view of a base sheet of the synthetic grass unit according to another embodiment of the invention;

FIG. 5 is a top plan view of the embodiment illustrated in FIG. 4;

FIG. 6 is a partial perspective view of an embodiment of the invention, showing a synthetic grass unit sliding on alignment tracks;

FIG. 7 is a side view of a base sheet of the synthetic grass unit according to another embodiment of the invention, showing an alternative structure of alignment grooves thereon;

FIG. 8 is a schematic view showing a cross-section of an alignment track used for engaging the alignment grooves shown in FIG. 7;

FIG. 9 is a partial side view of a modular synthetic grass turf assembly according to an embodiment of the invention, showing an interlocking structure between adjacent units;

FIG. 10 is a similar view to that illustrated in FIG. 9, showing an alternative interlocking structure between the adjacent units;

FIG. 11 is a top schematic view showing an arrangement for assembling the synthetic grass units using the interlocking structures illustrated in FIGS. 9 and 10;

FIG. 12 is a bottom plan view of a modular synthetic grass turf assembly according to another embodiment of the invention, showing the units having an alternative structure for interlocking with one another;

FIG. 13 is a perspective view of a looking ring used to interlock adjacent units as illustrated in FIG. 12;

FIG. 14 is a top schematic view showing a football field using a modular synthetic grass turf assembly according to the invention; and

FIG. 15 is a side schematic cross-section of another embodiment of t he modular unit.

### DESCRIPTION OF THE PREFERRED EMBODIMENTS

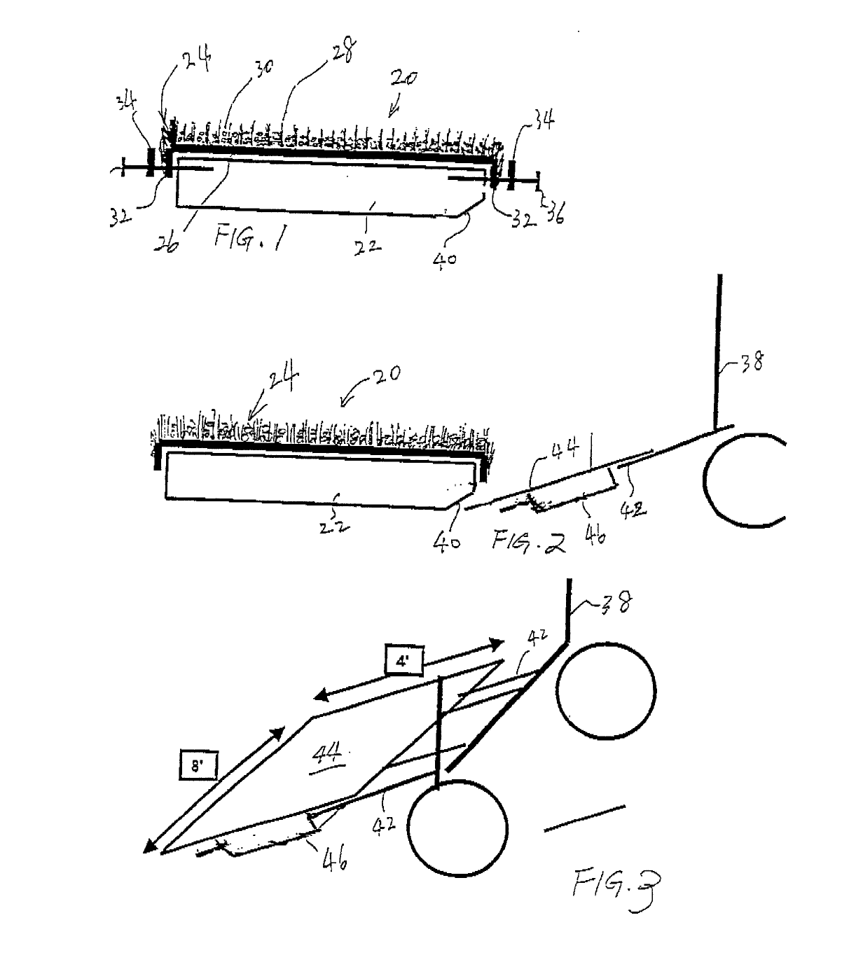

Referring to the drawings, and in particular to FIG. 1, a synthetic grass unit 20 is illustrated. The unit 20 includes a deformable and resilient base sheet 22 made of recycled plastic materials, measuring from 4 feet by 8 feet or longer and varies from ⅛″ inch to 5 inches in thickness. In this particular embodiment, the unit 20 is 4 feet by 8 feet, and 1 inch in thickness. The units 20 are preferably made from a continuous extruding process and cut into individual units. The material can also be made of a rubberized laminated fabric that is strong enough to withstand the pulling action of the fabric with the grass on it. A synthetic grass system 24 is placed on the top of the base sheet 22 and includes a sheet backing 26 and a plurality of synthetic ribbons 28 extending upwardly from the sheet backing 26, representing grass fibers. An infill layer 30 of a particulate material including rubber granules and sand and or only rubber granules and or only sand is deployed between the synthetic ribbons 28 to further improve the quality of the synthetic grass unit 20 for impact absorption. The synthetic grass system 24 including the infill layer 30 used in synthetic grass turf assemblies which are permanently installed is well known in prior art and is described, for example, in U.S. Pat. No. 5,958,527, issued to Prevost on Sep. 28, 1999 and assigned to the Assignee of this application, which is incorporated herein by reference.

The synthetic grass system 24 is wider than the base sheet 22 so that a strip portion 32 at each side thereof extends over the side edge of the base sheet 22 and suspends downwardly. A metal bar 34 having a length equal to or smaller than the length of the base sheet 22, preferably ½ inch wide and ⅛ inch thick, is provided at each side of the unit 20 to secure the synthetic grass system 24 to the base sheet 22. The metal bar 34 includes a plurality of mounting bores (not shown) for receiving mounting screws 36 extending therethrough and threadably engaged in the side of the base sheet 22 so that the metal bar 34 presses the strip portion 32 of the synthetic grass system 24 against the side of the base sheet 22. It is noted that the upper edge of the metal bar 34 must be lower than the top surface of the sheet backing 26 of the synthetic grass system 24 so that it is buried by the synthetic ribbons 28 and the infill layer 30 when the synthetic grass units 20 are placed side by side to form a continuous synthetic grass surface. The metal bar 34 should never protrude above the synthetic grass surface even when an area of the synthetic grass surface adjacent to the metal box 34 is pressed down under a load.

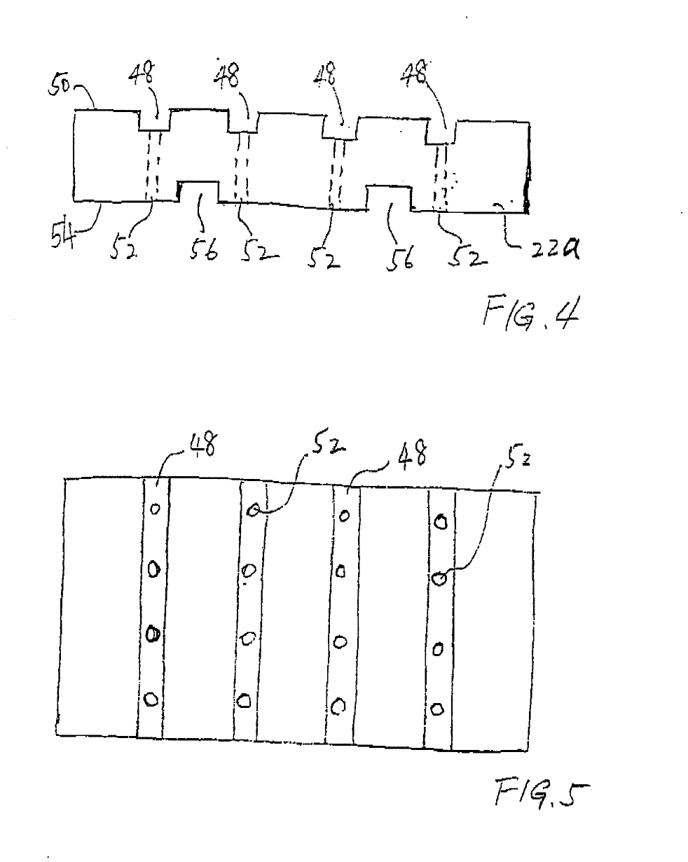

The synthetic grass unit 20 is conveniently transportable using a forklift vehicle 38 as shown in FIG. 2. The base sheet 22 is preferably beveled at one side as indicated at numeral 40 to facilitate the insertion of the fork arms 42 of the forklift vehicle 38. It is preferred to provide a metal sheet 44 which is more clearly illustrated in FIG. 3, to fully support the unit 20 in a horizontal position when the unit 20 is lifted and transported by the forklift vehicle 38. The synthetic grass unit 20 may be deformed under its own weight if the unit is supported directly on the forklift arms 42 without the metal sheet 44. The metal sheet 44 is preferably 7 feet long and about 4 feet wide to fit under the 8 foot by 4 foot base sheet 22 of the unit 20 and has two or more sleeves 46 welded to the underside of the metal sheet 44 into which the forklift arms 42 can easily slip.

It is also preferred that the forklift arms 42 are longer than the width of the metal sheet 44 whereby the tip portions of the forklift arms 42 protrude from the outside of the metal sheet 44 and are enabled to penetrate the stacking rack This will keep the space between the units 20 to a minimum, resulting in more units 20 per moveable rack and much less storage room required.

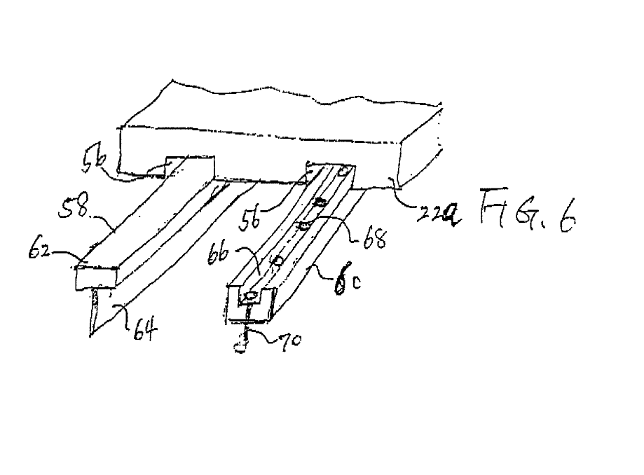

A drainage system is necessary if the synthetic grass units 20 are used to assemble a synthetic grass surface in an outdoor stadium. FIG. 4 illustrates another embodiment of the deformable and resilient base sheet 22a which is also extruded from recycled plastic materials. A plurality of drainage channels 48 are provided at the top surface 50 of the base sheet 22a which may be extruded at the same time as the base sheet 22a is fabricated. A plurality of drainage bores 52 is provided in each drainage groove 48, spaced apart from one another and extending vertically through the base sheet 22a to drain water from the synthetic grass system 24 placed on the top thereof, similar to that shown in FIG. 1, down to a drainage system (not shown) below the base sheet 22a. Similar drainage grooves can be extruded at the bottom surface of the base sheet 22a (not shown) so that water can be collected in and drained away through the drainage channels formed on the bottom surface 54 of the base sheet 22a when the drainage grooves of each synthetic grass unit 20 align wit those on adjacent units. The cross-section of the drainage channels 48 is not necessarily square and might be any shape, such as a semicircle. One or two alignment channels 56 may be extruded on the bottom surface 54 of the base sheet 22a. The drainage bores 52, however, are drilled as a separate process.

The extruded channels 56 and the additional drainage grooves extruded on the bottom surface of the base sheet 22a will restrain the entire unit 20 from moving backward or forward when the forklift vehicle 38 shown in FIG. 2 either deposits the unit 20 on the rack or picks up the unit 20 from the rack.

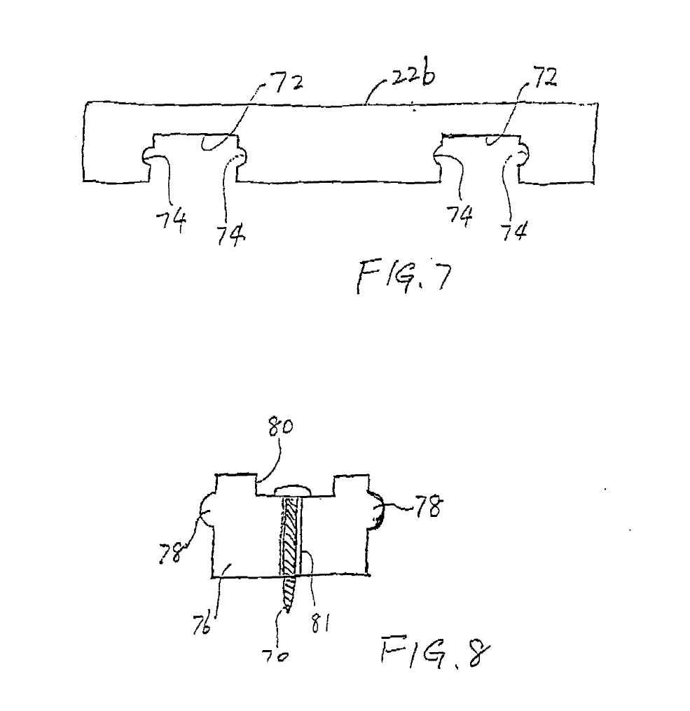

In FIG. 6, alignment tracks 58 and 60 are illustrated for engagement with the alignment channels 56 of the base sheet 22a. The track 58 has a generally “T”-shaped cross-section, including a top beam section 62 and a relatively thin plate section 64 perpendicularly fixed to the middle line of the bottom surface of the top beam section 62, and extending longitudinally along the entire length of the beam section 62. The track 58 is attached to a ground surface by inserting the plate section 64 down into an existing groove extending on the ground surface until the beam section 62 abuts the ground surface. The track 60 is formed in a different structure from the track 58 as another example. The track 60 generally is a beam having a rectangular cross-section and a groove 66 on the top surface and extending longitudinally along its entire length. A plurality of mounting bores 68 is provided in the groove 66, spaced apart from one another for receiving mounting screws 70 (only one shown). The mounting screw 70 threadably engages the ground surface when the track 60 is mounted onto the ground surface.

The cross-section of the alignment channels 56 and the alignment tracks 58 and 60 may vary, and a further example is illustrated in FIGS. 7 and 8.

A deformable and resilient base sheet 22b includes two alignment channels 72 as shown in FIG. 7. The base sheet 22b may have other structural features similar to those shown in FIGS. 1 and 4, are not redundantly described and not shown in FIG. 7, The alignment channel 72 has a generally rectangular cross-section and a semi-circle cross-sectional groove 74 extending on each side wall of the alignment channel 72 along the entire longitudinal length. Accordingly, the alignment track 76 includes a corresponding ridge 78 having a semi-circle cross-section protruding from each side of the track 76, and extending longitudinally along its entire length. Similarly to the track 60, the track 76 has a longitudinal groove 80 and a plurality of mounting bores 81 (only one shown) in the grooves 80 extending through the track 76 for receiving the respective mounting screws 70. The alignment track 76 not only ensures that the adjacent synthetic grass units 20 are aligned with one another but also prevent each unit from being lifted upwardly from the ground. The alignment function of the synthetic grass unit 20 not only helps facilitate water drainage but also is effective when the synthetic grass units 20 are used as advertisement or lettering function units because they are interlocked in position.

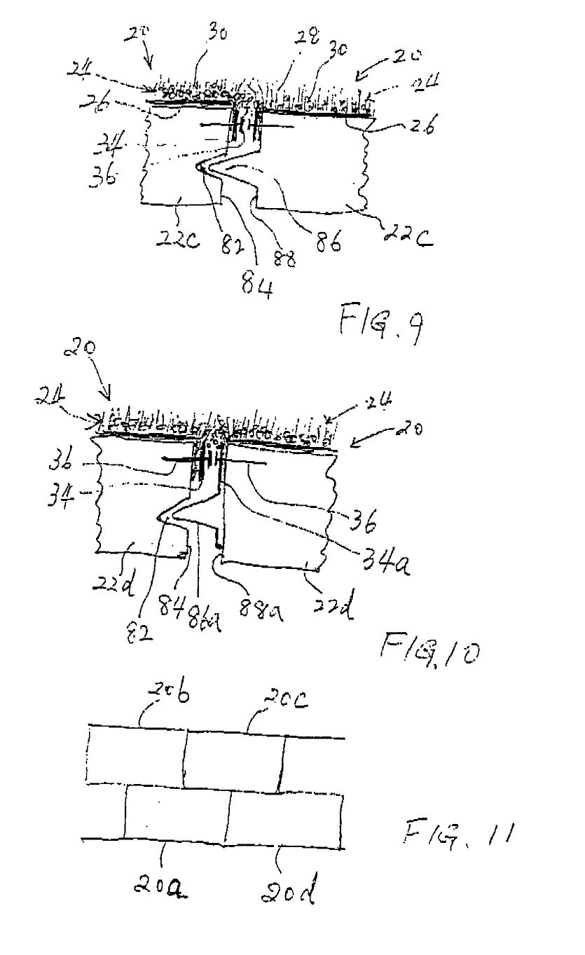

The use of the alignment structures described above, however, is limited to certain circumstances, such as outdoor stadia. In other circumstances, such as halls and gymnasia having wood floors and other ground surfaces, the installation of the alignment tracks on the ground will damage the finish of ground surfaces, which is not acceptable. Therefore, it is desirable to provide alternative interlocking means without the need to mount tracks or other engagement members to the ground. FIG. 9 illustrates such an embodiment of synthetic grass units 20 having such an interlocking mechanism provided therebetween. The like structures of the units 20 shown in FIG. 9 are indicated by the same numerals as shown in FIG. 1 and are not redundantly described here, The synthetic grass unit 20 has a deformable and resilient base sheet 22c having a groove 82 in a “V”-shaped cross-section on one side surface 84 extending longitudinally along the entire length of the side surface 84. At the other side of the base sheet 22c, there is a ridge 86 having a corresponding triangular cross-section protruding from the side surface 88 and extending longitudinally along the entire length of the side surface 88. The ridge 86 of the base sheet 22c of one unit 20 is received, in the groove 82 of the base sheet 22c of the adjacent unit 20 when these units 20 are laid side by side. A gap is formed between the two side surfaces 84 and 88 because of the thickness of the metal bars 34, screw heads 66, and the strip portion of the sheet backing 26 with the synthetic grass ribbons 28 between the side surfaces 84 and 88. Therefore, the ridge 86 must protrude farther than the groove 82 is recessed. In this particular embodiment, each metal bar 34 is 1/16 inch thick, each screw head 36 is 1/16 inch and the sheet backing 26 combined with the synthetic grass ribbons 28 pressed by the metal bar 34 is about 1/16 inch thick. Therefore, a ½ inch gap is formed between the side surfaces 84 and 88. In order to interlock the adjacent sides of the units 20, the ridge 86 must protrude from the side surface 88 more than ½ inch. For example, the ridge 86 may protrude 1½ inches and the groove is recessed about 1 inch. The gap of ½ inch between the adjacent synthetic grass units 20 is relatively small in contrast to the dimensions of each unit which are 4 feet by 8 feet. After the synthetic grass units 20 are assembled together on a sports field and the top-dressing is done on site, the relatively small gap between adjacent units will be covered by the synthetic grass ribbons 28 and the particulate mixture of the infill layer 30, and, therefore, these small gaps have no practical effect on the continuous synthetic grass surface.

By stapling the grass to the top of the recycled plastic sheet and trimming the grass along the top edge of the plastic sheet, the side edge thickness can be reduced by having only a thin strip of rubber, also stapled to the side of the recycled plastic sheet. This could eliminate the metal strip if the frequency of use of the removable system is such that minor damage over time is not a concern.

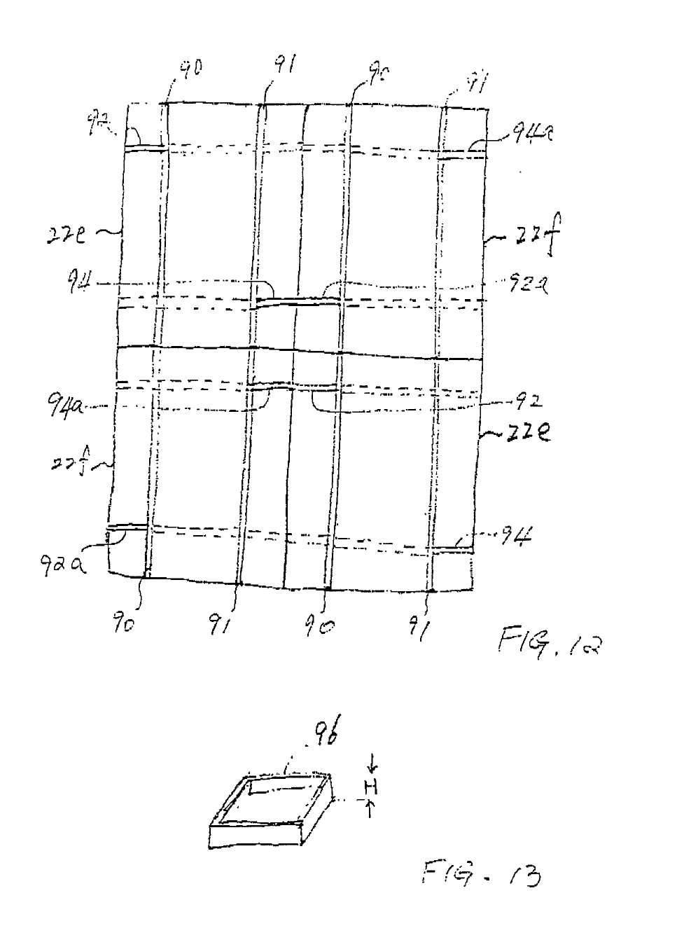

FIG. 10 shows an alternative embodiment of the interlocking means of the synthetic grass units 20. The deformable and resilient base sheet 22d has a structure at one side similar to that of a base sheet 22c, including the groove 82 in a “V”-shaped cross-section on the side surface 84. However, the other side of the base sheet 22d has a flat side surface 88a that does not include a ridge protruding therefrom like the ridge 86 shown in FIG. 9. A ridge 86a having a triangular cross-section is formed on the metal bar 34a which is much wider than the metal bar 34 used at the one side of the unit 20 to secure the synthetic grass system 24 to the base sheet 22d. The metal bar 34a is twice as wide as the metal bar 34 so that the upper portion of the metal bar 34a includes the mounting bores to perform the same securing unction as the metal bar 34 does, while a lower portion of the metal bar 34a performs the same interlocking function as the ridge 86 of the base sheet 22c. The ridge 86a that extends longitudinally along the entire length of the metal bar 34a is may be replaced by a plurality of metal pins protruding from the metal bar 34a and spaced apart from one another while the “V”-shaped groove 82 is replaced by corresponding bores for receiving such metal pins protruding from the metal bar 34a. Nevertheless, the “V”-shaped groove and the triangular cross-sectional ridge on the metal bar 34a are more easily made. The groove 82 can be extruded at the same time as the base sheet 22d is produced, and the ridge 86a can be produced at the same time as the metal bar 34a is manufactured in a stamping process.

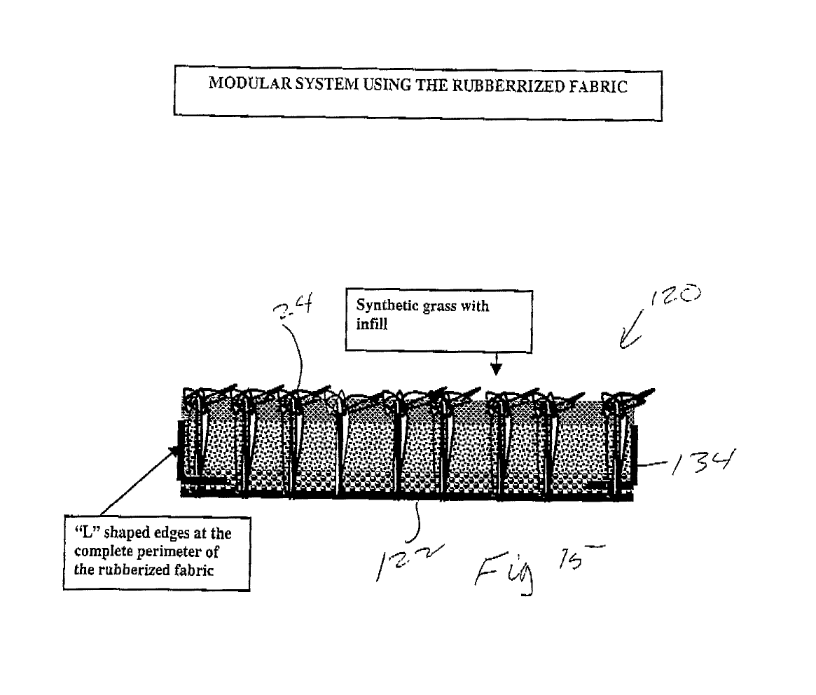

The means for interlocking adjacent synthetic grass units illustrated in FIGS. 6-10 only interlock the adjacent units in a same line or in a same column if the units are deployed in an array of lines and columns as illustrated in FIG. 14. In order to interlock the adjacent units into both lines and columns at the same time, the groove 82 and the ridge 86 are needed not only on the respective sides of the base sheet 22c but also the respective ends of the base sheet 22c. If the synthetic grass units 20 are deployed on the ground as illustrated in FIG. 11, each unit 20 needs only one pair of grooves 82 and ridges 86 on the respective sides to interlock all adjacent units which abut its periphery. As shown in FIG. 11, unit 20a is interlocked with units 20b and 20c. The unit 20a does not directly interlock to 20d because there is no s interlocking means provided between unit 20a and unit 20d. Nevertheless, unit 20d is interlocked to unit 20c and, therefore, the unit 20a and unit 20d are interlocked through unit 20c to which the unit 20a and unit 20d are commonly locked. The layout of a modular synthetic grass assembly illustrated in FIG. 11, however, is not convenient in some applications, and positioning the units in an array of lines and columns as shown in FIG. 14 is sometimes desirable.

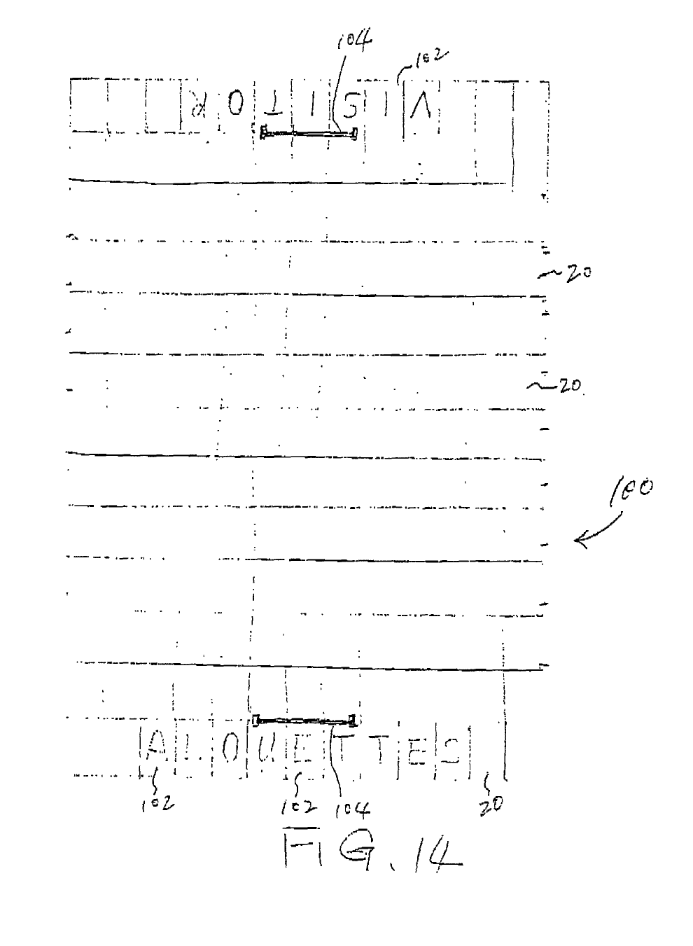

A further embodiment of the interlocking structure is developed for interlocking adjacent units into both lines and columns at the same time. The modular synthetic grass turf assembly includes a first group of the synthetic grass units 20 having deformable and resilient base sheets 22e and a second group of the synthetic grass units 20 having deformable and resilient base sheets 22f. Each of the base sheets 22e and 22f is extruded with two parallel channels 90 and 91 extending on the bottom surface through its entire length between the two opposite ends, similar to the alignment channels 56 shown in FIG. 4. In the first group, a first transverse channel 92 is provided on the bottom surface of each base sheet 22e extending inwardly from a first side near the first end and terminating at the first channel 90 which is closer to the first side. A second transverse channel 94 is provided on the bottom surface of the base sheet 22e, extending inwardly from the second side near the second end of the base sheet 22e and terminating at the second channel 91 which is closer to the second side. In the second group, a first transverse channel 92a is provided on the bottom surface of each base sheet 22f, extending inwardly from the first side near the second end of the base sheet 22f, and terminating at the first channel 90. A second transverse channel 94a is provided on the bottom surface of the base sheet 22f, extending inwardly from the second side near the first end of the base sheet 22f, terminating at the second channel 91. Therefore, when two synthetic grass units from the first group and two synthetic grass units from the second group are positioned side s by side on the ground as shown in FIG. 12, the transverse channels 94, 94a, 92, 92a and a section of channels 90 and 91 form a continuous channel in a rectangular or square shape on the adjacent corner area of the four units.

An aluminum, metal, or hard rubber locking ring 96 is provided, as illustrated in FIG. 13. The locking ring 96 has an identical geometry to the continuous channel formed in the adjacent corner area of the four units shown in FIG. 12. All channels shown in FIG. 12 have an equal width, and the locking ring 96 has a thickness smaller than the channel width so that the locking ring 96 fits in the continuous channel formed in the adjacent corner area of the four units. All channels shown in FIG. 12 are preferably of equal is depths, and the locking ring 96 has a height H tat is smaller than the depth of the channels to ensure that the four units shown in FIG. 12 are placed flat on the ground when they are interlocked by the interlocking ring 96.

An alternative method of making the transverse channels 92, 92a, 94 and 94a is to extend each of the transverse channels across the entire base sheet (22e or 22f) between the first and second sides as shown in broken lines in FIG. 12, whereby the base sheets 22e are identical to base sheets 22f and there is no need to divide the synthetic grass units 20 into two different groups.

An example application is illustrated in FIG. 14. A football game playing field is provided using the modular synthetic grass turf assembly 100 according to the invention. The sports field can be prepared with any type of ground selected from stabilized sand, crushed stone, asphalt, concrete, graded and compacted earth, other artificial surfaces and any firm substrate. Synthetic grass turf units 20 generally illustrated in FIG. 1, which may incorporate in part or entirely any embodiments as described above, are prepared individually in a workshop which may be located remotely from the stadium. The synthetic grass turf assembly 100 includes a majority of regular grass units 20 for the green grass surface and a number of synthetic grass units 102 on top of which an individual letter is illustrated in a colour different from the green. However, the units 102 have identical structures to units 20 and are compatible to be laid side by side adjacent to units 20. The individually prepared units 20 and 102 are lifted by a forklift vehicle, such as illustrated in FIGS. 2 and 3, and are stored on standard storage racks. The standard storage racks loaded with the synthetic grass units 20 and 102 are transported to the stadium, and the units 20 and 102 are individually positioned on the prepared ground according to a predetermined layout arrangement. In the application for a football game playing surface as illustrated in FIG. 14, a majority of the area of the surface is formed with the synthetic grass units 20 fit side by side in an array of lines and columns. A number of units 102 for lettering the host name and visitor name are selectively placed in the respective end sections of the field. One or more units presenting a team logo may also be positioned in those sections (not shown). A number of units 20 having advertising marks may be placed on the end sections or side strip sections of the field (not shown). However, each end section beyond the goal gate 104 may include more than one line of units, The football field illustrated in FIG. 14 is only for exemplary purposes. When the modular synthetic grass turf assembly 100 installed in the stadium is to be used for the next game with different teams, the majority of units 20 do not need to be changed, only those units 102 with lettering or marks need to be changed to reflect new team names or logos. For this purpose, a number of lettered or marking units 102 is prepared in the workshop and transported to the site. A forklift vehicle is used to remove those units 102 which are required to be changed from their locations, and position the respective new lettered or marking units 102 in place as required. When the football game playing surface needs to be changed to a baseball game playing surface, it is suggested that the entire modular synthetic grass turf assembly 100 is disassembled, and individual units are loaded on storage racks and transported back to the workshop or a storage facility because the layout of the baseball game playing surface is different from the layout of the football surface. It would not be convenient to make a baseball game playing surface using the same synthetic grass turf assembly for the football game playing surface. Unlike a rectangular football game playing surface, the baseball game playing surface is generally sectorial including a diamond shaped soil ground for positioning the bases. Therefore, a number of unusually shaped synthetic grass units are needed to form such a baseball game playing surface. Those unusually shaped units may be pre-manufactured in the required shapes and individually assembled in the workshop. It is also possible to cut the regular units to form the unusual shapes just like cutting and shaping a wood piece. After preparation in the workshop, all units are transported to the stadium site and assembled in generally the same way as the modular synthetic grass turf assembly 100. It is noted that on site top dressing after the installation of the modular synthetic grass turf assembly is suggested because it improves the even quality of the surface, and the gaps between adjacent units can be well covered by the infill layer of particulate mixture and the synthetic grass.

Another material that can be used is a flexible rubberized fabric such as used on conveyor belts. This material is extremely strong and flexible so that when the grass is installed on this fabric, the end of the fabric could be pulled horizontally towards a flatbed trailer platform in order for the fabric with the grass to slide onto the platform on a horizontal plane. By having a slip-sheet in between the layers of movable panels the next panel to be stored could simply be pulled on top of the previous one thereby eliminating the need for racking material in between the panels. This would substantially reduce the removal and installation time but would also reduce the storage space and thereby storage costs. The Edges of the rubberized fabric could have an “L” shaped flexible border affixed around the perimeter of the fabric to hold the infill in the grass.

Velcro systems and or a combination of belting material could be added to the extremities of the fabric in order to affix a removable pulling device for displacement of the large panels.

Another method of having a totally removable surface is to have the infilled grass permanently affixed to the plastic panels of a thickness of between ¼″ to 5″ in an all green or solid color format without any line markings at all. The lines could then also be permanently affixed to the same plastic material and the line sections could simply be removed with all the infill still in the line and be replaced by the same solid color grass in order to make the field markings disappear entirely without any hint that they ere there at all. By using this format, the field lining system can be completely engineered to be installed at the initial installation and be removable for specific sports in far less time that it takes to remove the entire field surface. This would reduce the wear and tear on the field and make it last longer as well as substantially reduce the storage space needed.

Another method of making removable lines on a prepared asphalt or concrete base is to cut channels out of the base where the lines could be inserted in a manner that would allow removal and replacement of the lines with another color. Predesigned and planned layout of field lines could be easily incorporated in the base preparation. Some of these line channels could also serve as drainage channels in order to evacuate water faster than standard methods.

To move the flexible rubberized fabric with the grass installed on them they could be pulled horizontally towards a flatbed trailer platform in order for the fabric with the grass to slide onto the platform on a horizontal plane. By having a slip sheet in between the layers of movable rubberized panels the next panel to be stored could simply be pulled on top of the previous one thereby eliminating the need for racking material in between the panels. This would substantially reduce the removal and installation time but would also reduce the storage space and thereby storage costs.

Modifications and improvements to the above described embodiments of the invention may become apparent to those skilled in the art. The foregoing description is intended to be exemplary rather than limiting. The scope of the invention is, therefore, intended to be limited solely by the scope of the appended claims.

1. A unit for a modular synthetic grass turf assembly for providing an activity surface comprising a base sheet and a synthetic grass system including at least a sheet backing and a plurality of synthetic ribbons, the synthetic grass system being placed on the top of the base sheet and secured thereto, and the base sheet being adapted to be laid flat on a support surface, and to fit side by side with respect to a base sheet of another such adjacent unit to provide a substantially flat and substantially continuous synthetic grass surface.

2. A method for providing a synthetic grass activity surface using modular synthetic grass units comprising steps of:
a) preparing a substantially flat surface for supporting the synthetic grass activity surface in a first location;
b) transporting from a second location a plurality of synthetic grass units to the first location; each of the units including a deformable and resilient base sheet and a synthetic grass system placed on top of the base sheet and secured thereto; and
c) placing the units on the supporting surface according to a predetermined layout and fitting the units side by side to provide a substantially flat and substantially continuous synthetic grass surface.
